(19) United States
(12) Patent Application Publication
(10) Pub. No.: US 2003/0206386 A1
(43) Pub. Date: Nov. 6, 2003

(54) Power supply isolation during motor spinup

(76) Inventors: Christopher Lawrence Hill, Apple Valley, MN (US); Matthew Edward Hastings, Bloomington, MN (US); Garry Edward Korbel, New Prague, MN (US)

Correspondence Address: David K. Lucente, Seagate Technology LLC, Intellectual Property - COL2LGL, 389 Disc Drive, Longmont, CO, 80503, US

(21) Appl. No.: 10/303,368

(22) Filed: Nov. 25, 2002

Related U.S. Application Data
(60) Provisional application No. 60/376,800, filed on May 1, 2002.

(51) Int. Cl. H02H 7/08

(52) U.S. Cl. 361/29

(57) ABSTRACT

The present invention includes apparatus and methods to suppress transients that would otherwise have an effect on a power supply. The present invention accomplishes this by providing a power supply transient suppressor between the power supply and an inductive load, such as a spindle motor of a disc drive. The power supply transient suppressor is turned off at certain desired times so that transients caused by the inductive load do not affect the power supply. One apparatus to accomplish this suppression is to use an isolation transistor and a blocking diode. The blocking diode can be a discrete device or can be inherent in the isolation transistor. The isolation transistor is turned on and off so that undesired transients are not passed to the power supply. For example, during spin up of the spindle motor, the isolation transistor can be turned on and off to block the transients from passing to the power supply.

### CROSS-REFERENCE TO RELATED APPLICATIONS

This application claims priority from United States Provisional Application No. 60/376,800 filed on May 1, 2002 and entitled POWER SUPPLY ISOATION DURING MOTOR SPINUP.

### FIELD OF THE INVENTION

The present invention relates generally to disc drives. In particular, the present invention relates to power supply isolation during spindle motor spinup in a disc drive.

### BACKGROUND OF THE INVENTION

A hard disc drive is used to store information in a computer. The drive can contain a disc that is rotated by a spindle motor. The spindle motor operates responsive to the application of current. Accordingly, the spindle motor can accelerate, decelerate (sometimes referred to as “brake”) and operate at certain rpms.

### SUMMARY OF THE INVENTION

The present invention includes apparatus and methods to suppress transients that would otherwise have an effect on a power supply. The present invention accomplishes this by providing a power supply transient suppressor between the power supply and an inductive load, such as a spindle motor of a disc drive. The power supply transient suppressor is activated at certain desired times so that transients caused by the inductive load do not affect the power supply.

One apparatus to accomplish this suppression is to use an isolation transistor and a blocking diode. The blocking diode can be a discrete device or can be inherent in the isolation transistor. The isolation transistor is turned on and off so that undesired transients are not passed to the power supply. For example, during spin up of the spindle motor, the isolation transistor can be turned on and off to block the transients from passing to the power supply.

These and various other features as well as advantages which characterize the present invention will be apparent upon reading of the following detailed description and review of the associated drawings.

### BRIEF DESCRIPTION OF THE DRAWINGS

FIG. 1 shows a block diagram of the present invention.

FIG. 2 shows a circuit diagram of a preferred embodiment of the present invention.

### DETAILED DESCRIPTION OF ILLUSTRATIVE EMBODIMENTS

While this invention is susceptible of embodiment in many different forms, there is shown in the drawings and will be described in detail specific embodiments with the understanding that the present disclosure is to be considered as an exemplification of the principles of the invention and is not to be limited to the specific embodiments described.

A disc drive can employ a three-phase brushless DC spindle motor that draws current from a power supply. This power supply can be a customer power supply or it can be a power system that controls anywhere from one drive to many drives in a disc array. The three-phase motor places an inductive load on the power supply, a type of load which can cause line transients. The transients can be both positive and negative depending on the direction of the current and the voltage. These transients can be due to the high slew rates used to switch current through the motor phases. They are also due to inductive flyback when commutating or re-routing motor current from one motor phase to another. These transients are particularly severe when accelerating a motor from a stop to full rpm (e.g. in the range of about 10000 to 16000 rpm) or braking. This severity is caused by the flyback current being equal to the motor current, which in the case of acceleration can be at its maximum.

In certain applications, arrays of ten or more discs are coupled to a single power supply. The supply system can become unstable due to motor flyback or other types of transients which can cause negative supply transients, or even cause current to flow back from the disc drive into the power supply. This can cause power supply faults that can cause disc drive voltage monitors to initiate a power fault shutdown process. Such power fault shutdowns are unacceptable for customer requirements.

These transients can be filtered or reduced by various means. Bulk capacitance on the supply lines is one method, with hundreds of microfarads of tantalum, ceramic or electrolytic capacitance used for filtering. This method is expensive and consumes much space on the disc drive circuit card. And although it helps reduce the problem, it does not eliminate it completely.

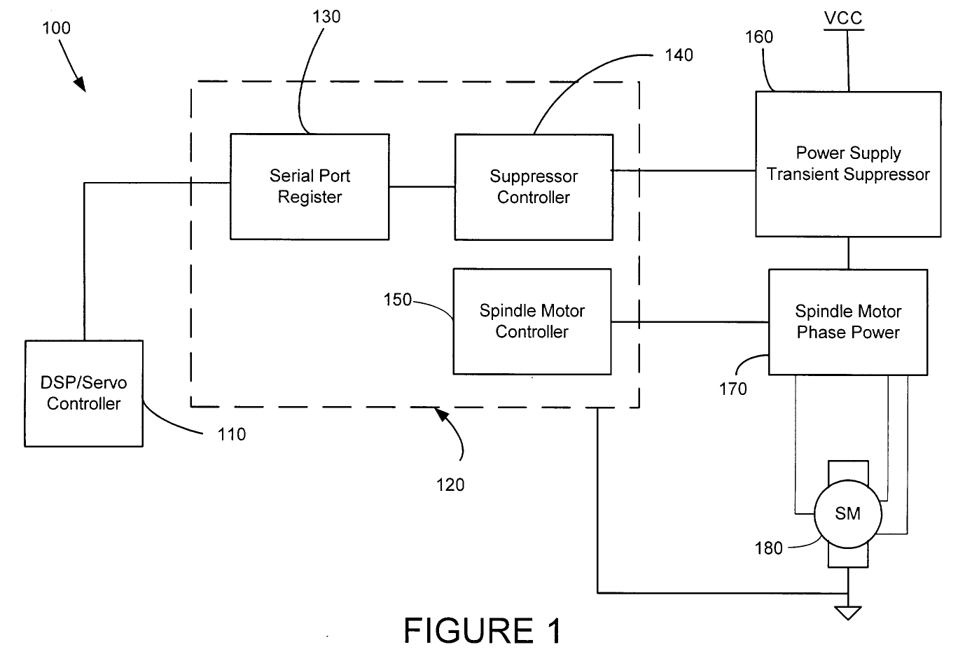

The present invention utilizes a method that at least minimizes power supply transients caused by an inductive load, such as a spindle motor. In particular, the present invention eliminates the negative currents during spinup of the spindle motor from being applied to the power supply. This method involves the use of a blocking diode during spinup, which will isolate the transients from the power supply. Referring to FIG. 1, a block diagram 100 of the preferred embodiment of the present invention is shown. A DSP/Servo controller 110 is coupled to a motor control block 120. In particular, DSP/Servo controller 110 is coupled to a serial port 130 that is included in motor control block 120. Serial port 130 is coupled to a blocking controller 140 that is also included in motor control block 120. Blocking controller 140 is coupled to a power supply transient suppressor 160. Power supply transient suppressor 160 couples the power supply to a spindle motor phase power block 170. Spindle motor phase power block 170 is controlled by a spindle motor controller 150. Spindle motor phase power block 170 provides the power to the different phases of spindle motor 180.

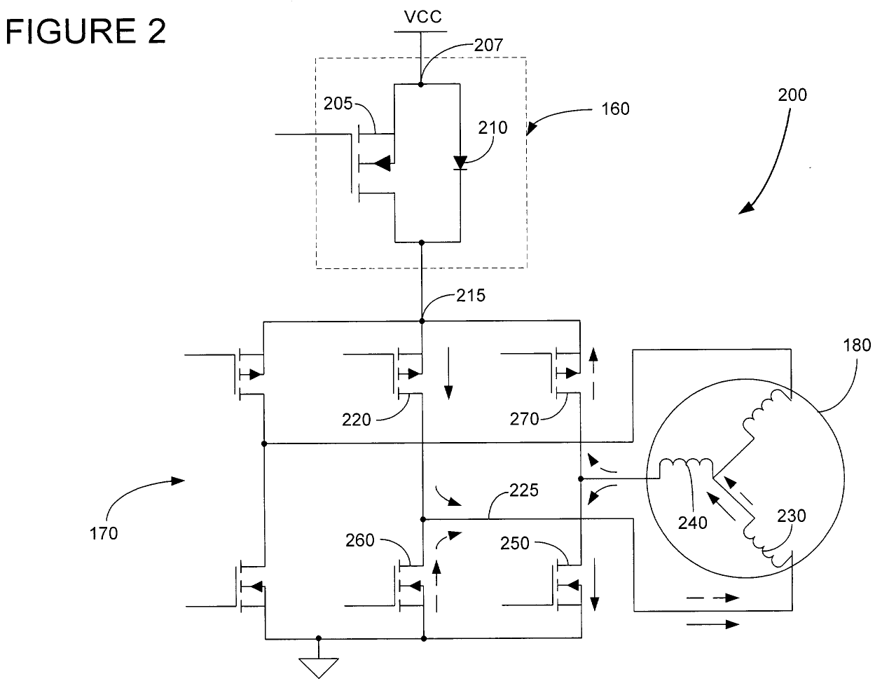

Referring to FIG. 2, one cause of a transient from spindle motor 180 will be explained as an illustration. Power is provided from node 215 through “on” transistor 220 and lead 225 to inductive windings 230 and 240. The power continues through “on” transistor 250 to the common ground. When transistors 220 and 250 are turned off, power is provided through transistor 260 and lead 225 to inductive windings 230 and 240. The power then proceeds through transistor 270 to node 215. The power is conducted by either transistors 260, 270 being turned “on” or diodes inherent in those transistors. If power supply transient suppressor 160 were not provided, the power through transistor 270 can cause a transient on node 207, which will cause a transient on the power supply Vcc. That is not desirable.

The methods and apparatus of the present invention overcome this transient by utilizing power supply transient suppressor 160. Power supply transient suppressor 160 can include, for example, a device or circuit. To illustrate, the preferred embodiment of the present invention uses a preferred low-impedance isolation MOSFET 205 and a blocking diode 210 arranged as shown in FIG. 2. Alternatives for blocking diode 210 can be a discrete diode or an inherent diode in the type of transistor or device chosen for isolation transistor 205. For example, an n-type depletion MOSFET can be used. Power supply transient suppressor 160 is used to block the effects on a power supply VCC of transients provided by spindle motor 180. In particular for the case described above, transistor 205 can provide power to node 215 from node 207 (coupled or connected to power supply Vcc) in order to power the inductive windings of spindle motor 180.

When a transient occurs at node 215, isolation transistor 205 is preferably off so that a transient path is not provided from node 215 to node 207. Alternatively, isolation transistor 205 can be turned off while the transient occurs at node 215. In that case, isolation transistor 205 is turned off to minimize the effect of the transient passing on to node 207. Blocking diode 210, due to its orientation, will also block current from node 215 to node 207 at that time. As a result, transients caused by spindle motor 180 are not passed on to power supply Vcc through node 207.

Power supply transient suppressor 160 can be activated during the motor spinup, or portions of the motor spinup, when the negative current spikes are the most troublesome. Blocking diode 210 is preferably bypassed by transistor 205 or other transistor during normal motor up-to-speed operation in order to save power. In order to control isolation transistor 205, the motor control block 120 preferably has a single bit added to serial port register 130. This bit will allow a DSP in the DSP/Servo Controller 110 to control the state of isolation transistor 205 during non-power fault conditions. Under DSP-controlled motor spinup, the DSP can select this bit to turn off the isolation transistor 205, which causes the blocking diode 210 to become part of the circuit during the entire spinup or portions thereof. This method is particularly advantageous during motor tach checks when motor flyback currents have the highest magnitude. This bit can be deselected during full speed operation, or during the portions of spinup when reverse current transients are not a significant factor to save power.

In more detail, the control of power supply transient suppressor 160 can be controlled in many ways. As described above, DSP/Servo controller 110 sets a bit in serial port register 130. That bit can be used by suppressor controller 140 in different ways. In one embodiment, suppressor controller 140 may pass the bit directly to power supply transient suppressor 160. In another embodiment, suppressor controller 140 can amplify or otherwise modify the bit and then provide it to power supply transient suppressor 160. In a further embodiment, the bit can be used as an enable bit for suppressor controller 140. Once enabled, suppressor controller 140 can provide a control signal to power supply transient suppressor 160. The control signal can be generated by circuitry within suppressor controller 140. That circuitry can use, for example, signals that are used to control spindle motor phase power block 170.

Therefore, during motor spinup, when the motor current levels are high and flyback transients are maximum, the power supply isolation technique of the present invention is used to prevent the flyback transients from forcing current from the disk drive back into the power supply. Isolating the spindle motor in this manner acts to stabilize certain power systems by eliminating reverse current transients that might otherwise be routed back to the power supply. The spindle motor isolation method of the present invention can be applied during the entire spinup process, or only at certain points, such as motor tach checks, where the motor phase flyback currents are maximum. The motor isolation method is used only as needed, and is minimized to reduce any extra loading or power loss.

Alternatively, the present invention can be used where the isolation occurs if the transients are greater than a predetermined threshold. This threshold can be measured or determined statistically or on a used-basis.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts and values for the described variables, within the principles of the present invention to the full extent indicated by the broad general meaning of the terms in which the appended claims are expressed. For example, the particular elements may vary depending on the particular application for the servo system while maintaining substantially the same functionality without departing from the scope of the present invention. In addition, although the preferred embodiment described herein is directed to a spindle motor controller for a disc drive system, it will be appreciated by those skilled in the art that the teachings of the present invention can be applied to other systems, without departing from the scope of the present invention. The disc drive can be based upon magnetic, optical, or other storage technologies and may or may not employ a flying slider.

What is claimed is:

1. An apparatus comprising a power supply transient suppressor that selectively couples a power supply to an inductive device, wherein the power supply transient suppressor is controlled to suppress a transient to the power supply from the inductive device.

2. The apparatus of claim 1 wherein the power supply transient suppressor includes an isolation transistor and a blocking diode.

3. The apparatus of claim 2 wherein the blocking diode is inherent in the isolation transistor.

4. The apparatus of claim 1 wherein the power supply transient suppressor is effective when the transient is greater than a threshold value.

5. The apparatus of claim 4 wherein the inductive device is a spindle motor and the power supply transient suppressor is effective during spinup of the spindle motor.

6. An apparatus that minimizes power supply transients comprising a power supply isolation device that couples a power supply to an inductive load, wherein the power supply isolation device prevents power supply transients to the power supply from the inductive load.

10. A method of reducing power supply transients comprising the step of decoupling a spindle motor from a power supply to prevent power supply transients.

11. The method of claim 10 wherein the decoupling occurs at least during portions of a spinup of the spindle motor.

12. The method of claim 10 wherein the decoupling step is performed by a power supply transient suppressor that is controlled to turn off at desired times while power is supplied.

13. The method of claim 12 wherein the desired times correspond with the power supply transients being greater than a predetermined value.
